(19) United States
(12) Patent Application Publication
(10) Pub. No.: US 2008/0215248 A1
(43) Pub. Date: Sep. 4, 2008

(54) Method and Device for the Measurement and Identification of Biofilms and Other Deposits Using Vibration

(75) Inventors: Joaquim Gabriel Magalhaes Mendes, Porto (PT); Luis Manuel Ferreira De Melo, Porto (PT); Ana Alexandra Da Silva Pereira, Porto (PT); Adelio Miguel Magalhaes Mendes, Porto (PT)

Correspondence Address: SUGHRUE MION, PLLC, 2100 PENNSYLVANIA AVENUE, N.W., SUITE 800, WASHINGTON, DC, 20037, US

(73) Assignee: UNIVERSIDADE DO PORTO, Porto (PT)

(21) Appl. No.: 12/066,352

(22) PCT Filed: Aug. 29, 2006
(86) PCT No.: PCT/IB06/52992

§ 371 Date: Mar. 10, 2008

(30) Foreign Application Priority Data
Sep. 9, 2005 (PT) 103344

(51) Int. Cl. G06F 19/00

(52) U.S. Cl. 702/19

(57) ABSTRACT

The present invention concerns a method and device to monitor the formation and removal of biofilms and other deposits in ducts, reservoirs and equipments, using vibration. The afore mentioned device is composed by an element that generates vibration (1) and an element that senses vibration (2), fixed on the external surface of a duct, reservoir or equipment (3). An electrical signal is generated by an electronic data acquisition unit (4) connected to the element that generates the vibration (1). The duct, reservoir or equipment (3) vibration leads to a signal in the vibration sensing element (2) which is measured and processed by the electronic data acquisition unit (4). The present invention is able to monitor the formation of deposits on surfaces and it can be applied, for example, to fluid distribution systems and fluid heating/cooling systems.

### TECHNICAL DOMAIN

The present invention concerns a method and device for real-time monitoring of biofilms and other deposits attached to the surfaces of ducts, reservoirs and equipments.

### STATE OF THE ART

One of the major and more frequent problems in ducts, reservoirs and other equipments is the build up of undesirable biofilms and deposits. Fluids flowing in ducts and other equipment usually carry some type of nutrients that favor the development of microbial colonies which attach to surfaces in the most suitable places.

After this initial attachment, further adhesion of micro-organisms becomes easier, leading to the rapid formation of a biofilm. The development of such microbial layers causes not only an increase in the resistance to flow, but also an increase in the heat transfer resistance to the outside of the surface, resulting in higher energy costs and in an overall reduction of the efficiency of the fluids distribution systems.

Additionally, biofilms are matrices that favor the incorporation and development of pathogenic micro-organisms, and their release to the external fluid which, in the case of drinking water systems, constitutes a risk to public health.

Some micro-organisms can also induce corrosion on the surfaces of ducts, increasing the maintenance costs of such infrastructures.

Such deposits may have different causes, generically classified in three main groups:
a) deposits that are essentially of a biological nature, formed by micro-organisms (biofilms);
b) deposits that are essentially abiotics, formed by the adhesion of suspended particles or by the precipitation/crystallization of dissolved compounds;
c) mixed deposits that contain both biological and non-biological (abiotic).

The real-time detection of such deposits is crucial to prevent or minimize their development, since it enables the application of appropriate counter-measures in due time. With such purpose in mind, several monitoring methods were developed, some of them being in effective use at the moment, and others seeming to be potentially useful (bibliography [1] to [12]), based on:
a) the measurement of pressure drop in pipes [1], [12] and U.S. Pat. No. 6,311,546 B1;
b) the measurement of heat transfer resistance of the deposits [1], [11,12];
c) the measurement of electromagnetic radiation, that includes the following methods:
C1. differential turbidimetry that detects the increase in liquid turbidity caused by the deposit next to the surface [1], [3] and [9];
C2. Optical fiber, which measures the light dispersion caused by the adhesion of particles or micro-organisms to an optical fiber probe inserted on the surface under study [1], [3] and [5];
C3. absorption of infrared radiation by the deposit formed on a transparent surface [1], [4], US 2002/0060020 A1, or by using a Multiple-Attenuated Internal Reflection Infrared spectrophotometer MAIR-IR, WO 02/093145, or even by using ultra-violet radiation, U.S. Pat. No. 4,912,332;
C4. analysis of the image obtained from the exterior of the duct, by using a CCD camera, U.S. Pat. No. 6,498,862 B1.
d) the measurement of the vibration reflected or absorbed by the material deposited on the surface:
d1. Quartz Crystal Microbalance(QCM), that measures changes in the crystal vibration due to the mass of deposit formed on the crystal surface [1], [3], [7], [10] and U.S. Pat. No. 5,487,981. Patent n° U.S. Pat. No. 5,734,098 suggests the simultaneous measurement of fluid viscosity and density in order to obtain a more accurate result;
d2. Photo Acoustic Spectroscopy, which measures the effect caused by the absorption of electromagnetic radiation on the vibration characteristics of the deposit formed on the surface of a crystal [1], [3] and [6];
d3. Surface Acoustic Waves (SAW), created by ZnO electrodes deposited on a piezoelectric substratum, typically a quartz crystal, WO 02/095940 A1 and US 2004/0133348 A1;
d4. the measurement of the acoustic impedance of the deposit by analyzing the wave frequency and phase, U.S. Pat. No. 6,701,787;
e) the measurement of electrochemical properties, including:
e1. open corrosion potential, that measures the difference in potential between the met allic surface where the deposit is formed and a reference electrode [1,2] and U.S. Pat. No. 5,576,481;
e2. dielectric spectroscopy, which measures changes in the electric capacity of the medium caused by the presence of micro-organisms near the surface [1].
f) periodic automatic weighing of sampling coupons, U.S. Pat. No. 6,405,582 B1.
g) manual sampling of coupons, U.S. Pat. No. 5,488,856, U.S. Pat. No. 5,049,492.

The methods based on pressure drop and heat transfer measurements, (a) and (b), are not sensitive enough to the presence of small amounts of deposit, that is, to the initial phase of adhesion. The methods based on heat transfer measurements are particularly appropriate for monitoring heat exchange equipments, although they are subject to well known experimental errors associated to the measurement of small temperature differences in solid surfaces.

The differential turbidimetry (c1), the optical fiber sensor (c2), the infrared sensor (c3) and the image sensor (c4) can be applied only to the deposition on transparent or semi-transparent surfaces (which is rarely the case of ducts and industrial equipment), the same is also true in Quartz Crystal Microbalance devices (d1) and in Photo Acoustic Spectroscopy (d2). The direct contact of the sensing element with the fluid, as well as the fact that the materials of the duct and the sensor surface are different are also disadvantages in many applications. In the case of the quartz crystal microbalance it is also necessary to assure that the flow, if it exists, is laminar. The method (d3) is specifically appropriate for the detection of solid particles.

The techniques described in (e), measurement of electrochemical parameters, has the disadvantage of being only applied to deposits formed on metallic surfaces. Such methods are particularly sensitive to the influence of external electric and magnetic fields.

The technique (f) cannot be applied to ducts neither allows real-time data acquisition.

Finally, method (g) is not automatic and, therefore, has a limited interest.

Transducers based on acoustic waves (d) SAW (Surface Acoustic Wave), TSM (Thin Shear Mode), QCM (Quartz Crystal Microbalance) are composed of a polished substratum of piezoelectric material, usually quartz, and two electrodes, the emitting element and the sensor, respectively, located on the end zones of the substratum. On the central zone, a chemically inert metallic element, typically gold is placed. The wave propagation characteristics of this element vary with the chemical substance that is supposed to detect (SAW). These devices can make use of Rayleigh waves or surface shear waves, called ‘Love Waves’, which are more appropriate for liquids. The frequency used for the excitation lies in the ultrasound range, normally hundreds of MHz. In the QCM, the deposit formed on the quartz surface modifies the mass and consequently affects the resonance frequency of the crystal. These are expensive devices, often used in chemical analysis and quite sensitive to external factors, therefore demanding very carefully operating procedures. However, their main disadvantage for monitoring biofilms and other deposits is the need of direct contact with the sample, which eliminates the possibility of measuring such deposits on the most common surfaces in ducts and other equipments. Additionally, turbulent flow produces significant interferences on the output signal of these devices.

### SUMMARY OF THE INVENTION

The objective of the present invention is to disclose a simple and economical solution for in-line real-time detection of the deposits formed on the surfaces of ducts, reservoirs or equipments made of different materials.

The solution is based on the fact that the formation and/or removal of the deposit modifies the wave propagation properties of the surface, which can be measured by a suitable sensor.

Thus, the objective of the present invention is to provide a method for monitoring the formation of biofilms and other deposits using vibration, characterized to include the following steps:
a) using an element that generates vibration (1) and an element that senses vibration (2) attached to the surface to be monitored (3);
b) generation of a vibration signal by an electronic data acquisition unit (4), supplying the element that generates the vibration (1);
c) measurement and processing the signal acquired from the element that senses the vibration (2) by the electronic data acquisition unit (4);
d) identification of the characteristic values of the output signal of the sensing element (2) by the electronic data acquisition unit (4), using current techniques of digital signal processing.

Moreover, it is also objective of the present invention to disclose a device for measuring and identification of biofilms and other deposits using vibration, according to the above method, comprising:
a) an element that generates vibration (1) and an element that senses the vibration (2); and
b) an electronic data acquisition unit (4) for the generation of the vibration signal and for the acquisition and processing of the signal coming from the element that senses the vibration (2).

### SHORT DESCRIPTION OF THE FIGURES

FIG. 1: Schematic representation of a segment of a semi-circular duct in Perspex (3), closed by a flat surface, also in Perspex, with grooves to enable the insertion of coupons (8) and the device for monitoring biofilms (7). The element that generates vibration (1) and the element that senses vibration (2) are applied in the outside of the PVC surface (9) inserted in the duct (3).
1. Element that generates vibration
2. Element that senses vibration
3. Duct
7. Monitoring device
8. Coupons
9. PVC surface
10. Water flow

FIG. 2: Schematic representation of an alternative to FIG. 1. To increase the sensitivity, the vibration power applied to the duct can be increased by using a power amplifier (5). In the same way, the output signal of the element that senses the vibration can be connected to a signal conditioning interface (6), to be filtered and amplified. Certain types of accelerometers, used in the vibration measurements, demand the use of charge amplifiers.
1. Element that generates vibration
2. Element that senses the vibration
3. Duct
4. Electronic data acquisition unit
5. Power amplifier
6. Signal conditioning interface

FIG. 3: Formation of Pseudomonas fluorescens biofilm in turbulent flow. Representation of the sensor signal as a function of time, after being mathematically processed.

FIG. 4: Changing of the device signal output with the wet mass per unit of area, for the biofilm represented in the FIG. 3.

FIG. 5: Comparison of the damping factor variation of the PVC surface vibration during one experiment with silica and other with a biofilm deposit.

FIG. 6: Example of the vibration signal measured using an accelerometer, for a sinusoidal vibration signal of 0.6 V amplitude and 3.0 kHz frequency, applied to the piezoelectric element fixed to the PVC surface.

FIG. 7: Schematic representation of a water pipe. The element that generates vibration and the element that senses the vibration are glued to the outside of the referred duct.
1. Element that generates vibration
2. Element that senses the Vibration
3. Duct
4. Electronic data acquisition unit

### DETAILED DESCRIPTION OF THE INVENTION

Ducts and other equipments in contact with fluids are subjected to the formation of undesirable deposits that can affect negatively the energy performance of industrial units, constitutes a risk to public health and degrades the material on the equipments.

The present invention has substantial advantages over the existing techniques for industrial applications, being: the device can use different surface materials, like metals, polymers and glass; it is not required the sensor element to be in direct contact with the fluid, neither with the deposit formed on the surface under study; it enables to monitor the entire area between its elements; it gives an instantaneous response; it enables a correlation between the output signal and the physical properties of the deposit. The described device is cheap, compact, easy to maintain and operate, can be applied in industrial circulation fluid systems and reservoirs and it can sense small deposit masses (under 100 μg/cm²). The device can be applied in-line or in side stream, with laminar or turbulent flow.

The device disclosed here can detect the presence of deposits, measure them and identify their nature through mathematic analyses of the response of the surfaces to a pre-defined excitation.

The device object of this invention can have different configurations, being generically composed by an element that generates vibration (1), an element that senses vibration (2), a duct, reservoir or equipment (3), an electronic data acquisition unit (4), that generates the vibration signal, acquires and process the signal from the element that senses the vibration (2), as represented in the FIG. 7. The element that generates vibration (1) and the element that senses the vibration (2) are fixed to the surface to be monitored, with a distance that can change according to the application, from 1 millimeter up to several meters. The element that generates vibration can be any actuator type since it can induce vibration on the surface (3), for example, a solid state actuator (piezoelectric, piezostrictive or magnetostrictive), electric, pneumatic, hydraulic or mechanic. The element that senses the vibration, as well, can be of different type, with or without contact, since it can be able to measure the vibration, displacement or strain of the surface, or even the force exerted by the vibration of the surface. For example, a solid state sensor, an accelerometer, an optical sensor, an ultrasonic sensor, a strain sensor or a force sensor.

Both elements are, for example, of piezoelectric type (ceramic, polymer or quartz) and the device is controlled by an electronic data acquisition unit (4). Alternatively, the element that generates vibration (1) is of piezoelectric type and the vibration sensor (2) is an accelerometer. The element that generates vibration and the element that senses the vibration, can be fixed inside or outside a duct, reservoir or other equipment to be monitored, placed in pairs. They can be connected to a single unit (4) that can make the digital signal processing of several sensors. The electronic data acquisition unit can be connected directly to the element that generates vibration (1), or having a power amplifer in between (5) to increase the power of the vibration induced in the duct (3).

In the same way, the signal of the vibration sensor can be connected directly to the electronic unit (4) or having a signal conditioning interface in between for amplification and filtration (6). The electronic data acquisition unit can be based on a computer with a data acquisition board (for example from National Instruments®), or a DSP board (for example from Texas Instruments®) or also a board based on a microcontroller (for example from Atmel®) able to generate and acquire data. Alternatively, a function generator (for example from Agilent®) can be used for the generation of the vibration and an oscilloscope (for example from Tektronix) for signal acquisition from the element that senses the vibration.

To increase the sensitivity of the monitor device, the signal can have a frequency close to the resonance frequency of the surface, although it can be operated at other frequencies. Normally, the vibration signal is periodic and can be, for example, a sinusoidal or square wave type.

After being acquired by the electronic unit (4), the signal from the vibration sensor must be mathematically processed by using well known tools for digital processing signal (for example, FFT, average, amplitude, phase shift, area below the curve, etc.) or by using techniques of artificial intelligence (like for example, neuronal networks).

The electronic data acquisition unit identifies the characteristic values of the vibration signal: amplitude, frequency, peak values, phase shift, damping, among others, that can be related with the deposits (deposition/removal) and their physical properties.

Namely, it was verified that the amplitude and the frequency are related to the mass of the deposit.

### APPLICATION EXAMPLE

### Example 1

In the following example, the element that generates vibration (1) and the element that senses the vibration (2) are glued to the outside of the PVC surface (9) fixed to the flat surface of a water duct with a semi-circular cross section (3)—FIG. 1. This duct has, on the flat surface, six grooves for PVC coupons of 2 cm² to be removed during the experiment, for the analysis of the physical properties (masses and thickness) and/or microbiological properties of the deposit. This way, it is possible to monitor the formation of the deposit and establish a relationship between the signal obtained and the characteristic of the deposit.

The element that generates vibration (1) and the element that senses vibration (2) are piezoelectric ceramics of the bender type, with the dimensions of 25×7.5×0.4 mm glued with epoxy on the surface of the PVC board (9) and attached to the outer side of the duct. The distance between the element that generates vibration (1) and the element that senses vibration (2) is of 60 mm.

The electronic data acquisition unit (4) is based on a computer equipped with a data acquisition board, ref. PCI 6221 (National Instruments®). The signal generated by this unit is amplified by six times in the power amplifier (5) and then connected to the piezoelectric element that generates the vibration (1),—FIG. 2. The vibration signal is a sinusoid with a frequency of about 3 kHz, close to the resonance frequency of the biofilm monitor (7), and amplitude of 10 V. On the other side, the vibration of the PVC surface (9) is measured by the vibration sensor—a piezoelectric element—(2). The acquisition of the signal of this sensor is realized automatically by the computer (4) using a program developed in LabVIEW® 7.1 (National Instruments).

By using standard digital signal processing techniques, several characteristics of the output signal are calculated. Among them are the phase shift between the signal generated and acquired, the amplitude of the signal peaks, FFF, damping factor, integral, etc. These parameters can be related with the process of formation/removal of the deposits in ducts and with the deposit structure.

During the experiments, vibration data is periodic acquired and processed (of about one hour interval). The amplitude of the FFr of the measured signal at the resonance frequency can be correlated to the mass of the deposit and, then, to the deposit formation/removal process on surfaces. Notice that this amplitude has an inverse variation with the amount of the deposit. For this reason, and in order to make the text easier to understand, the value corresponding to the monitor clean (starting time—before the deposition starts) is consider as a offset, being all amplitude values subtracted from this. This way, it will be used the variation of the output signal (output processed signal), to observe a direct relation between this parameter and the increase of the deposit in the surface.

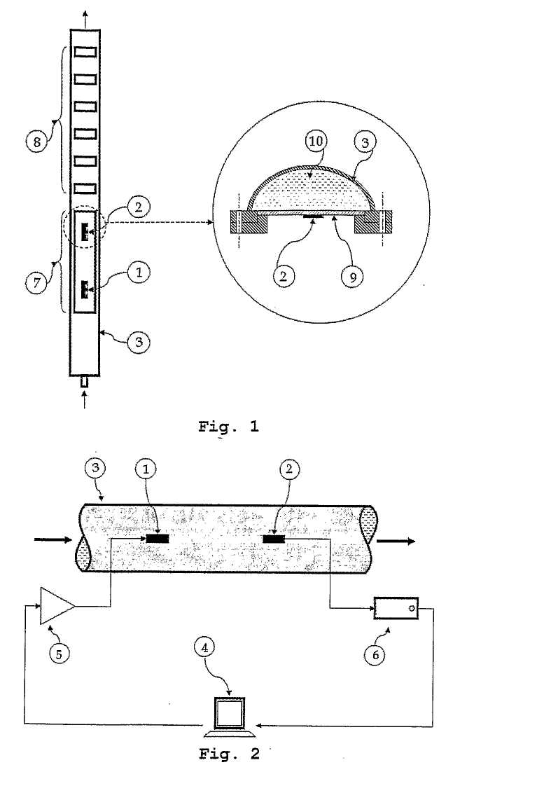

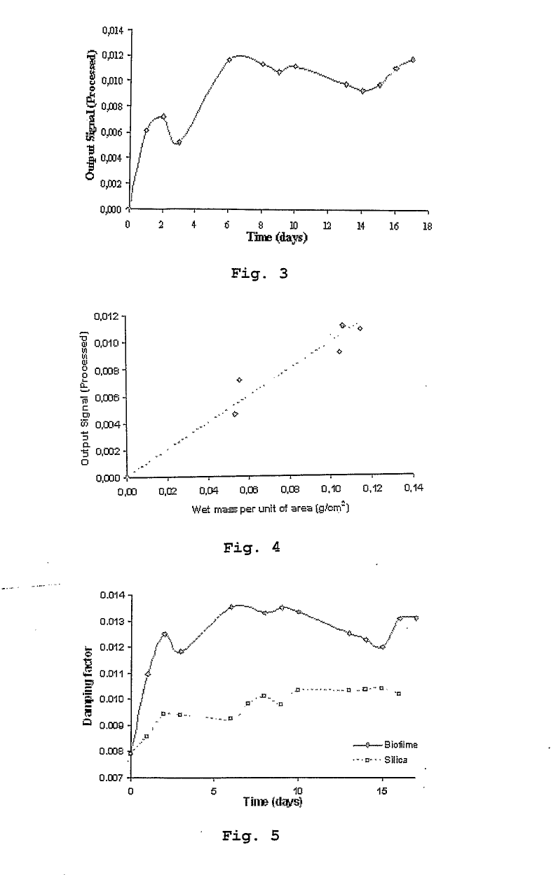

In FIG. 3 it can be observed that the variation of the output signal with time during the formation of the biofilm of Pseudomnonas fluorescens in turbulent flow, having been found a direct relation between the output signal and the wet mass per unit of area, FIG. 4.

### Example 2

In this example, the above referred procedure of example 1 was repeated, having been studied the silica deposition in turbulent flow instead of a biofilm.

The main conclusion presented in the example 1 is also valid for the example 2.

The variation of the output signal is directly related with the amount of deposit (wet mass per unit of area) in the duct. However, the output signal is different in both cases.

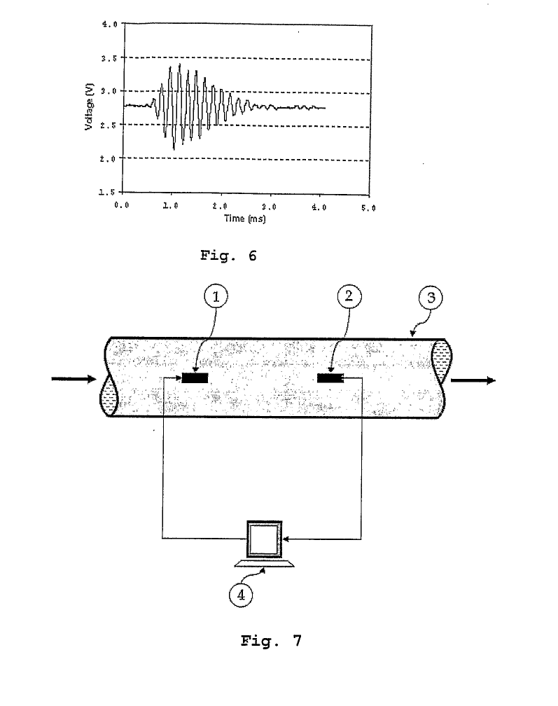

Silica is a rigid material (less elastic) than a biofilm, so the variation of the output signal is affected by a different damping factor. It can be observed that for identical masses of silica and biofilm, the variation of the output signal is smaller in the first case. Thus, the variation of the damping factor is a parameter that can be used to compare different types of deposits, since larger variations in the damping factor are observed for more elastic deposits (like the case of the biofilm, in comparison to the silica)—FIG. 5.

### Example 3

In example 3, it was used as a vibration sensing element, a high sensibility accelerometer—FIG. 6, instead of the piezoelectric element, which allows a reduction of the voltage applied to the element that generates the vibration and this way to release the power amplifier (5). Thus, the system becomes significantly simple, as illustrated in—FIG. 7.

The above examples are presented as illustrative, and they cannot intend to represent all the range of applications where this invention can be used.

### BIBLIOGRAPHY

[1] Janknecht P., Melo L. P., ‘On-line biofilm monitoring’, Re/Views on Environmental Bio/Technology 2:2-4, 269-283, 2003.

[2] Mollica A., Cristiani P., ‘On-line biofilm monitoring by ‘BIOX’ electrochemical probe’, Wat. Sci. & Tech. 47: 5, 45-49, 2003.

[3] Flemming H. C., ‘Role and levels of real-time monitoring for successful anti-fouling strategies—an overview’, Wat. Sci. & Tech. 47: 5, 1-8, 2003.

[4] Tinham P., Bott T. R., ‘Biofouling assessment using an infrared monitor’, Wat. Sci. & Tech. 47: 5, 39-43, 2003.

[5] Tamachkiarow A., Flemming H. C., ‘On-line monitoring of biofilm formation in brewery-water pipeline system with a fibre optical device’, Wat. Sci. & Tech. 47: 5, 19-24, 2003.

[6] Schmidt T., Panne U., Haisch C., Hausner M., Niessner R., ‘A new photoacoustic technique for depth-resolved in situ monitoring of biofilms’, Environ. Sci. Technol., 36: 19, 4135-4141, 2002.

[7] Hartmann, J., Teichmann, L., Horn, H., Borngraber, R., Lucklum, R., Hauptmann, P., ‘Quartz crystal microbalance for online-early-diagnosis of growing biofilms’, Proceedings of the International Specialized Conference on Biofilm Monitoring, Porto, Mar. 17-20, 2002.

[8] Cristiani P., Perboni G., Hilbert L., Mollica A., Gubner R., ‘Experiences on MIC monitoring by electrochemical techniques, Proceedings of the International Specialized Conference on Biofilm Monitoring, Porto, Mar. 17-20, 197-200, 2002.

[9] Klahre J., Flemming H. C., ‘Monitoring of biofouling in papermill process waters’, Wat. Res. 34 :14, 3657-3665, 2000.

[10] Nivens D. E., Palmer R. J., White D. C. ‘Continuous nondestructive monitoring of microbial biofilms: a review of analytical techniques’. J. Ind. Microbiol. 15: 263-276, 1995.

[11] Chenoweth J M, ‘Liquid fouling monitoring equipment’. In: Melo L. F., Bott T. R., Bernardo C. A. (eds) Fouling Science and Technology. Kluwer Academic Publisher, Dordrecht, 49-65, 1988.

[12] Melo L. F., Pinheiro J. D., ‘Fouling Test: Equipment and Methods’, in J. W. Suitor, A. M. Pritchard (eds) Fouling in Heat Exchange Equipment, pp 43-49, Amer. Soc. Mechan. Engrs.—Heat Transfer Division, New York, 1984.

### PATENTS

U.S. Pat. No. 6,311,546 B1—Dickinson et al., 6 Nov. 2001
US 2002/0060020 A1—Irwin et al., 23 May 2002
WO 02/093145 A1—Lucas e al. 15 May de 2001
U.S. Pat. No. 4,912,332—Siebel et al., 27 Mar. 1990
U.S. Pat. No. 6,498,862 B1—Pierson et al., 24 Dec. 2002
U.S. Pat. No. 5,487,981—Nivens et al. 30 Jan. 1996
U.S. Pat. No. 5,734,098—Kraus et al., 31 Mar. 1998
WO 02/095940 A1—Kalanar-Zadeh et al., 28 Nov. 2002
US 2004/0133348 A1—Kalanar-Zadeh et al., 8 Jul. 2004
U.S. Pat. No. 6,701,787 B2—Han et al., 9 Mar. 2004
U.S. Pat. No. 5,576,481—Beardwood, 19 Nov. 1996
U.S. Pat. No. 6,405,582 B1—Boettcher, 18 Jun. 2002
U.S. Pat. No. 5,488,856—Dirk, 6 Feb. 1996
U.S. Pat. No. 5,049,492—Sauer et al. 17 Sep. 1991

1. A method for using nano-vibrations for real-time monitoring of biofilms and other deposits, both rigid and visco-elastic, caused by fluids, that are attached to the surfaces of ducts, reservoirs and other equipments, wherein it comprises the following steps:
a) the use of an actuator (1) that produces nano-vibration waves propagating along the monitored surface (3) in a direction parallel to the fluid flow;
b) the use of a sensor (2) that captures the surface vibration wave downstream from the actuator;
c) the actuator (1) and sensor (2) being fixed on the outer side of the surface of the equipment to be monitored (3), at a fixed distance of 1 mm or more, along the flow direction, not in contact with the fluid flow;
d) periodically exciting the actuator (1) and capturing the propagated vibration with the sensor (2);
e) processing the acquired signal in order to obtain the time-decrease of the amplitude of the wave and, after applying Fast Fourier Transform, the amplitude of the spectrum peaks both to determine the mass of the biofilms and other deposits and to assess their visco-elasticity type;
f) providing integrated measurements of the properties of the biofilms and other deposits based on time-decrease of the amplitude of the wave and amplitude of the spectrum peaks along the flow direction, between the actuator (1) and the sensor (2).

2. A device for using nano-vibrations for real-time monitoring of biofilms and other deposits, both rigid and visco-elastic, caused by fluids, that are attached to the surfaces of ducts, reservoirs and other equipments, wherein it comprises:
a) an actuator (1) that produces nano-vibration waves, preferably of piezo-electric material;
b) a sensor (2) that captures the surface vibration wave, preferably of piezoelectric material and/or an accelerometer;
c) the actuator (1) and sensor (2) being fixed on the outer side of the surface of the equipment (3) to be monitored, at a fixed distance of 1 mm or more, along the flow direction, not in contact with the fluid flow;
d) means for processing the acquired signal consisting of a electronic unit (4) being composed by a computer and a data acquisition board, a DSP board or a board based on a microcontroller generation, acquisition and processing capabilities;
e) a power amplifier (5);
f) a signal conditioning interface (6).

3. A device according to claim 2, wherein the actuator and sensor being mounted in pairs on the outer surface along the flow direction.

4. A device according to claim 2, wherein it is applied to any type of solid surface material (3) with different geometries, including flat and round shapes.

5. A device according to claim 2, wherein it is applied to monitor both the buildup and the removal of biofilms and other deposits on surfaces.

6. A device according to claim 2, wherein it uses very small vibrations in a intermittent way that do not interfere with the normal development of the biofilms and other deposits.

7. A device according to claim 2, wherein it is installed in-line or in a side stream and applied to stagnant fluids and to fluids flowing in laminar or turbulent regime.

8. A device according to claim 2, wherein it identifies if the pipe is empty or the existence of bubbles in the fluid.

9. A device according to claim 2, wherein it measures the build up and removal of biofilms and other deposits both on fixed and free-vibrating surfaces.
